(19) United States
(12) Patent Application Publication
(10) Pub. No.: US 2025/0187337 A1
(43) Pub. Date: Jun. 12, 2025

(54) NOZZLE UNIT CONTROL METHOD AND INKJET RECORDING APPARATUS

(71) Applicant: KYOCERA Document Solutions Inc., Osaka (JP)

(72) Inventor: Masayuki Miyake, Osaka (JP)

(21) Appl. No.: 18/977,257

(22) Filed: Dec. 11, 2024

(30) Foreign Application Priority Data
Dec. 12, 2023 (JP) 2023-209084

(51) Int. Cl. B41J 2/165; B41J 2/045

(52) U.S. Cl. CPC B41J 2/16505; B41J 2/04528; B41J 2/04563; B41J 2/04566; B41J 2/04573; B41J 2/04581

(57) ABSTRACT

A processor times a capped time that is a duration time of a capped state of a nozzle unit when the ink is not being ejected, and an open time that is a duration time of an open state of the nozzle unit when the ink is not being ejected. The processor sets a number of times parameter relating to a number of times that a meniscus of the ink in a plurality of nozzles of the nozzle unit is oscillated according to the capped time and the open time. The processor generates the meniscus oscillation of the ink a number of times corresponding to the number of times parameter from when a request for image formation is received until when the image formation is started.

### INCORPORATION BY REFERENCE

This application is based upon and claims the benefit of priority from the corresponding Japanese Patent Application No. 2023-209084 filed on Dec. 12, 2023, the entire contents of which are incorporated herein by reference.

### BACKGROUND

The present disclosure relates to a nozzle unit control method and an inkjet recording apparatus for achieving an appropriate viscosity of ink before being ejected from a nozzle.

The inkjet recording apparatus includes a nozzle unit having a plurality of nozzles and a plurality of piezoelectric elements. The plurality of nozzles, by ejecting ink onto a sheet, form an image on the sheet.

The plurality of piezoelectric elements pressurize the ink supplied to the plurality of nozzles. The plurality of piezoelectric elements are provided so as to correspond to the plurality of nozzles.

When water in the ink evaporates, viscosity of the ink increases. In a case in which the viscosity of the ink supplied to each of the nozzles is high, ejection performance of the ink from each of the nozzles deteriorates when each of the piezoelectric elements operates.

In addition, the inkjet recording apparatus may include a cap that covers the plurality of nozzles. In addition, setting a number of times a micro-driving operation of the plurality of piezoelectric elements is performed in accordance with the time from when the decapped state of the nozzle unit begins to when printing begins is also known.

### SUMMARY

A nozzle unit control method according to one aspect of the present disclosure is a method for controlling a nozzle unit. The nozzle unit includes a plurality of nozzles capable of ejecting ink, and a plurality of piezoelectric elements that pressurize the ink supplied to the plurality of nozzles. The nozzle unit is selectively switched between a capped state in which the plurality of nozzles are covered by a cap and an open state in which the plurality of nozzles are opened by removing the cap. The nozzle unit control method includes a processor setting a number of times parameter related to a number of times meniscus oscillation of the ink in the plurality of nozzles in accordance with a capped time that is a duration time of the capped state of the nozzle unit when the ink is not being ejected, and an open time that is a duration time of an open state of the nozzle unit when the ink is not being ejected. Furthermore, the nozzle unit control method includes the processor oscillating the plurality of piezoelectric elements to generate a meniscus oscillation of the ink a number of times corresponding to the number of times parameter during a period from when a request for image formation by ejecting the ink is received until when the image formation is started.

An inkjet recording apparatus according to another aspect of the present disclosure includes one or more of the nozzle units, and the processor that implements the nozzle unit control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to a first embodiment.

FIG. 2 is a cross-sectional view of a nozzle unit in the inkjet recording apparatus according to the first embodiment.

FIG. 3 is a diagram showing the inkjet recording apparatus when the nozzle unit is in a capped state.

FIG. 4 is a block diagram showing a configuration of a control device in the inkjet recording apparatus according to the first embodiment.

FIG. 5 is a flowchart showing an example of a procedure of pre-ink ejection control in the inkjet recording apparatus according to the first embodiment.

FIG. 6 is a graph showing candidates for parameter setting rules in the inkjet recording apparatus according to the first embodiment.

FIG. 7 is a diagram showing a configuration of update status data in the inkjet recording apparatus according to the first embodiment.

FIG. 8 is a diagram showing a configuration of an inkjet recording apparatus according to a second embodiment.

FIG. 9 is a flowchart showing an example of a procedure of pre-ink ejection control in an inkjet recording apparatus according to a third embodiment.

FIG. 10 is a graph showing candidates for parameter setting rules in an inkjet recording apparatus according to a third embodiment.

### DETAILED DESCRIPTION

Hereinafter, embodiments according to the present disclosure will be described with reference to the drawings. Note that the following embodiments are examples according to the present disclosure and do not limit the technical scope according to the present disclosure.

### First Embodiment

The inkjet recording apparatus 10 according to the first embodiment is a printer, a facsimile apparatus, a copier, a multifunction peripheral, or the like that is capable of executing a printing process using an inkjet system.

The printing process is a process for forming an image on a sheet 9. The sheet 9 is a sheet-like image forming medium such as paper or a resin film.

### [Configuration of Inkjet Recording Apparatus 10]

The inkjet recording apparatus 10 includes a sheet storing portion 12, a sheet conveying device 2, an inkjet portion 3, an ink supply portion 4, a cap unit 6, a unit moving device 60, a control device 8, and the like. The inkjet portion 3 has a plurality of nozzle units 31.

The sheet conveying device 2, the inkjet portion 3, the ink supply portion 4, a cleaning unit 5, the cap unit 6, and the control device 8 are housed in a main body 11 of the inkjet recording apparatus 10.

The sheet conveying device 2 conveys the sheets 9 stored in the sheet storing portion 12 one by one along a sheet conveying path 20. Furthermore, the sheet conveying device 2 feeds out the sheet 9 on which the image is formed from the sheet conveying path 20. For example, the sheet conveying device 2 feeds out the sheet 9 from the sheet conveying path 20 to a discharge tray or another device at a downstream stage.

The sheet conveying device 2 includes a sheet feeding portion 21, a plurality of sets of conveying roller pairs 22, a first belt conveying unit 23, a second belt conveying unit 24, a pair of feeding rollers 25, and the like. The sheet feeding portion 21 feeds out the sheets 9 one by one from the sheet storing portion 12 to the sheet conveying path 20.

The plurality of sets of conveying roller pairs 22 take over the conveying of the sheet 9 from the sheet feeding portion 21 and convey the sheet 9 toward the first belt conveying unit 23.

The first belt conveying unit 23 is arranged below the inkjet portion 3. The first belt conveying unit 23 conveys the sheet 9 in a predetermined conveying direction DO while facing the front surface of the sheet 9 toward the inkjet portion 3.

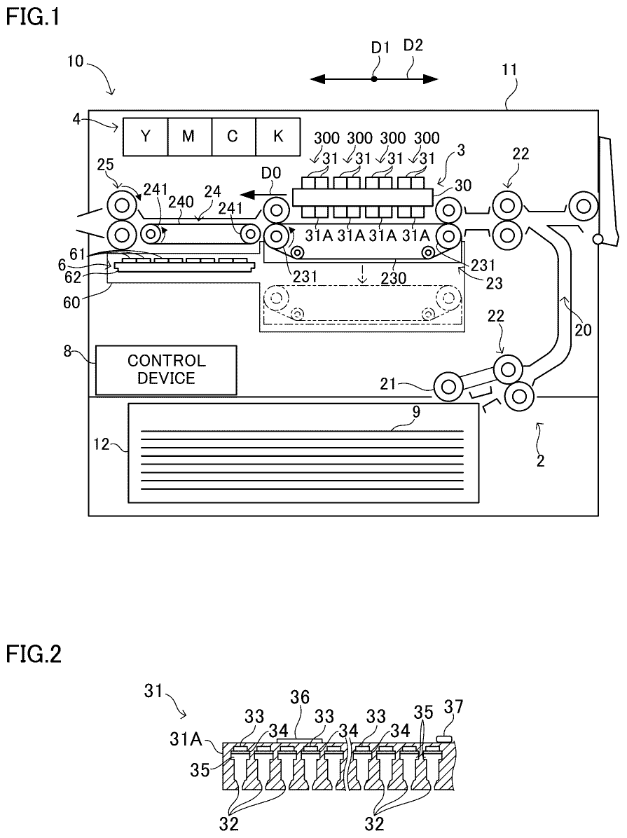

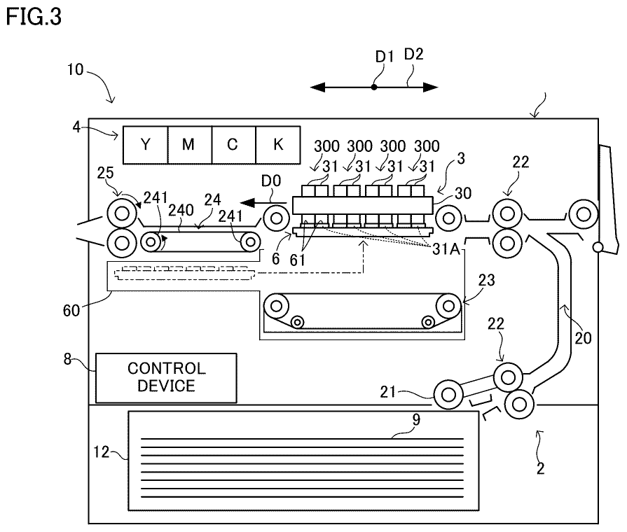

A direction perpendicular to the conveying direction DO is a main scanning direction D1, and a direction along the conveying direction DO is a sub-scanning direction D2 (see FIGS. 1 and 3).

In the first belt conveying unit 23, a plurality of tension rollers 231 support and rotate an endless first conveying belt 230. Thus, the first belt conveying unit 23 places the sheet 9 on the first conveying belt 230 and conveys the sheet 9 in the conveying direction DO. Furthermore, the first belt conveying unit 23 feeds out the sheet 9 to the second belt conveying unit 24.

The first belt conveying unit 23 is arranged at a conveying position or a belt retreat position. FIG. 1 shows a state in which the first belt conveying unit 23 is arranged at the conveying position, and FIG. 3 shows a state in which the first belt conveying unit 23 is arranged at the belt retreat position. In the present embodiment, the belt retreat position is a position vertically below the conveying position.

When the first belt conveying unit 23 is arranged at the conveying position, the first belt conveying unit 23 forms the sheet conveying path 20 between the first belt conveying unit 23 and the plurality of nozzle units 31. The belt retreat position is a position separated farther away from the nozzle units 31 than the conveying position.

The first belt conveying unit 23 is arranged at the conveying position when the printing process is performed. The second belt conveying unit 24 is arranged on the downstream side in the conveying direction DO from the first belt conveying unit 23 located at the conveying position.

In the second belt conveying unit 24, a plurality of tension rollers 241 support and rotate an endless second conveying belt 240. Thus, the second belt conveying unit 24 places the sheet 9 on which the image has been formed on the second conveying belt 240, conveys the sheet 9, and then feeds the sheet 9 out to the feeding roller pair 25.

The feeding roller pair 25 is arranged on the downstream side of the second belt conveying unit 24 in the conveying direction DO. The feeding roller pair 25 feeds the sheet 9 on which the image is formed to the outside of the main body 11.

The inkjet portion 3 includes a plurality of nozzle units 31 and a nozzle unit support 30 that supports the plurality of nozzle units 31. The plurality of nozzle units 31 eject multiple colors of ink toward the sheet 9 being conveyed by the first belt conveying unit 23, thereby forming an image on the sheet 9.

In the example shown in FIG. 1, the plurality of nozzle units 31 are divided into four line heads 300 corresponding to black, cyan, magenta, and yellow inks. The ink supply portion 4 supplies ink of each color to the plurality of nozzle units 31.

The four line heads 300 are arranged side by side in the sub-scanning direction D2. Note that it is also possible for the number of line heads 300 included in the inkjet portion 3 to be three, five or more.

Each of the plurality of nozzle units 31 has an ink ejection portion 31A facing the upper surface of the first conveying belt 230. The ink ejection portion 31A includes a plurality of nozzles 32 each capable of ejecting the ink (see FIG. 2). Furthermore, the ink ejection portion 31A includes a plurality of piezoelectric elements 33, a plurality of pressure chambers 35, and a plurality of vibration plates 34 (see FIG. 2).

The plurality of piezoelectric elements 33, the plurality of pressure chambers 35, and the plurality of vibration plates 34 are provided so as to correspond to the plurality of nozzles 32.

The plurality of pressure chambers 35 are respectively connected to the plurality of nozzles 32. The plurality of pressure chambers 35 form passages for ink to be respectively supplied to the plurality of nozzles 32. The ink in the plurality of pressure chambers 35 is supplied to the plurality of nozzles 32.

The plurality of vibration plates 34 form a part of partition walls of the plurality of pressure chambers 35. When a drive signal is supplied to each of the piezoelectric elements 33, the piezoelectric elements 33 pressurize the ink in the pressure chambers 35 via the corresponding vibration plates 34.

The drive signal is a pulse-width modulated continuous pulse signal. The drive signal is supplied from the control device 8 to each of the piezoelectric elements 33.

That is, when the driving signal is supplied from the control device 8 to each of the piezoelectric elements 33, the piezoelectric elements 33 pressurize the ink supplied to each of the plurality of nozzles 32.

The piezoelectric element 33 to which the drive signal is supplied vibrates with energy that causes ink to be ejected from the corresponding nozzle 32. That is, when the drive signal is supplied to each of the piezoelectric elements 33, each piezoelectric element 33 pressurizes the ink in the pressure chamber 35 to such an extent that the ink is ejected from the nozzle 32.

The ink pressurized by the piezoelectric element 33 to which the drive signal is supplied flows from the pressure chamber 35 into the corresponding nozzle 32 and is then ejected from the nozzle 32. The plurality of nozzles 32 eject ink onto the sheet 9 to form an image on the sheet 9.

In the example shown in FIG. 1, the plurality of nozzle units 31 are divided into four line heads 300 corresponding to black, cyan, magenta, and yellow inks. The ink supply portion 4 supplies ink of each color to the plurality of nozzle units 31.

The four line heads 300 are arranged side-by-side in the sub-scanning direction D2 and fixed in a predetermined positional relationship (see FIGS. 1 and 2). Note that it is also possible for the number of line heads 300 included in the inkjet portion 3 to be three, five or more.

The cap unit 6 is selectively arranged in one of a cap retreat position and a cap position. FIG. 1 shows a state in which the cap unit 6 is arranged at the cap retreat position. FIG. 2 shows a state in which the cap unit 6 is arranged at the cap position.

The cap unit 6 has a plurality of caps 61 and a cap support 62. When the cap unit 6 is arranged at the cap position, the plurality of caps 61 cover the plurality of nozzles 32 of each nozzle unit 31.

The unit moving device 60 moves the first belt conveying unit 23 and the cap unit 6. The unit moving device 60 executes a first unit arrangement process or a second unit arrangement process.

The first unit arrangement process is a process of arranging the cap unit 6 at the cap retreat position and arranging the first belt conveying unit 23 at the conveying position. The second unit arrangement process is a process of arranging the first belt conveying unit 23 at the belt retreat position and placing the cap unit 6 at the cap position.

The unit moving device 60 executes the first unit arrangement process before the printing process is executed. Furthermore, when the printing process corresponding to the printing request is completed, the unit moving device 60 executes the second unit arrangement process in a case in which no new printing request has been received.

In the following description, a state of the nozzle units 31 in which the plurality of nozzles 32 are covered by the caps 61 will be referred to as a capped state. In addition, a state of the nozzle units 31 in which the caps 61 are removed is referred to as an open state.

By executing the first unit arrangement process, the nozzle units 31 are set to the open state. By executing the second unit arrangement process, the nozzle units 31 are set to the capped state. The nozzle units 31 are selectively switched between the capped state and the open state.

When the nozzle units 31 are in the capped state, a rate at which the viscosity of the ink in the plurality of nozzles 32 in each of the nozzle units 31 increases is slowed down.

### [Control Device 8]

The control device 8 executes various types of data processing and controls the devices included in the inkjet recording apparatus 10. The control device 8 is an example of a control portion that controls the plurality of piezoelectric elements 33 and other devices.

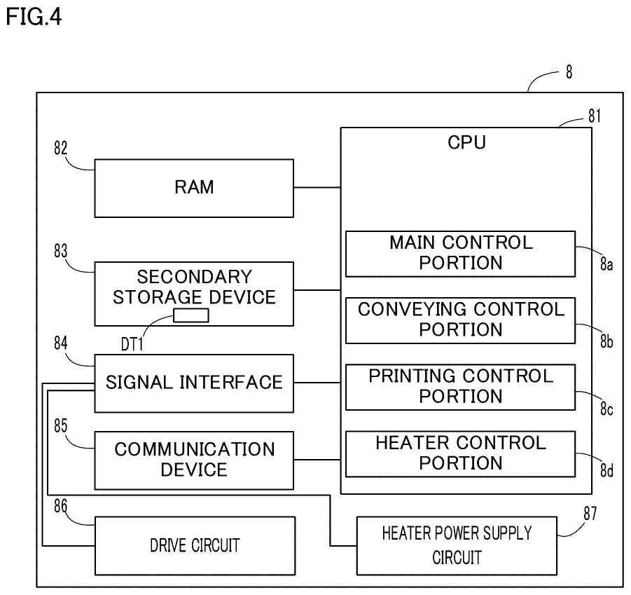

As shown in FIG. 4, the control device 8 includes a central processing unit (CPU) 81, a random access memory (RAM) 82, a secondary storage device 83, and peripheral devices such as a signal interface 84. Furthermore, the control device 8 includes a communication device 85 and a drive circuit 86.

The CPU 81 is a processor that executes various types of data processing and control by executing computer programs. The CPU 81 is an example of a processor that controls the plurality of piezoelectric elements 33 and other devices.

The RAM 82 is a computer-readable volatile storage device. The RAM 82 temporarily stores the computer programs executed by the CPU 81 and data output and referenced by the CPU 81 when executing various types of processing.

The secondary storage device 83 is a computer-readable non-volatile storage device. The secondary storage device 83 is capable of storing and updating the computer programs and various types of data. For example, a flash memory or a hard disk drive, or both, may be employed as the secondary storage device 83.

The signal interface 84 converts signals output by various types of sensors into digital data, and transmits the converted digital data to the CPU 81. Furthermore, the signal interface 84 converts a control command output by the CPU 81 into a control signal, and transmits the control signal to the device to be controlled.

The communication device 85 is capable of communicating with a host device and other devices (not shown). The host device is an information processing apparatus such as a personal computer or a smartphone operated by a user.

For example, the CPU 81 receives a printing job from the host device via the communication device 85. The inkjet portion 3 forms an image specified by the printing job on the sheet 9.

The drive circuit 86 receives the control signal from the CPU 81 via the signal interface 84. The drive circuit 86 outputs the drive signal to each of the plurality of piezoelectric elements 33 in accordance with the input control signal.

The drive circuit 86 generates the drive signals corresponding to the plurality of piezoelectric elements 33 in accordance with the contents of the control signal, and supplies the generated drive signals to the plurality of piezoelectric elements 33. The nozzles 32 eject an amount of ink according to the drive signals.

The CPU 81 includes a plurality of processing modules that are achieved by executing the computer programs. The plurality of processing modules include a main control portion 8a, a conveying control portion 8b, and a printing control portion 8c.

The main control portion 8a executes, for example, control to start various types of processing in response to operations on an operating device (not shown), and control of a display device (not shown).

The conveying control portion 8b controls the sheet conveying device 2 and the unit moving device 60. The printing control portion 8c causes the inkjet portion 3 to execute the printing process in synchronization with the conveying of the sheet 9 by the sheet conveying device 2.

The printing control portion 8c outputs the control signal to the drive circuit 86 via the signal interface 84. The printing control portion 8c controls the plurality of piezoelectric elements 33 via the drive circuit 86 to cause the inkjet portion 3 to execute the printing process.

As the temperature of the ink decreases, the viscosity of the ink increases. In a case in which the viscosity of the ink supplied to each of the nozzles 32 is high, the ejection performance of the ink from each of the nozzles 32 deteriorates when each of the piezoelectric elements 33 operates.

In the present embodiment, each nozzle unit 31 includes a heater 36 that heats the ink ejection portion 31A, and a temperature sensor 37 (see FIG. 2). That is, a heater 36 and a temperature sensor 37 are arranged in each nozzle unit 31.

Furthermore, the control device 8 includes a heater power supply circuit 87 that supplies power to the heater 36 (see FIG. 4).

Furthermore, the plurality of processing modules in the CPU 81 include a heater control portion 8d (see FIG. 4). The heater control portion 8d controls the heater 36 via the heater power supply circuit 87.

The heater control portion 8d operates the heater 36, thereby shortening a first print time. The first print time is the time from when the inkjet recording apparatus 10 receives a printing request until when the inkjet recording apparatus 10 starts the printing process.

The temperature sensor 37 detects the temperature of the ink ejection portion 31A. That is, the temperature sensor 37 detects the temperature of the nozzle unit 31. For example, the temperature sensor 37 is a thermistor.

The heater control portion 8d controls the heater 36 by feedback control based on the temperature detected by the temperature sensor 37 and the target temperature.

The viscosity of the ink also changes in a state in which the plurality of nozzles 32 are covered with the caps 6.

Therefore, the printing control portion 8c executes pre-ink ejection control, which will be described later. The pre-ink ejection control is control for achieving an appropriate viscosity of the ink before it is ejected from each of the nozzles 32 without causing each of the nozzle units 31 to eject the ink.

[Ink Oscillation Control]

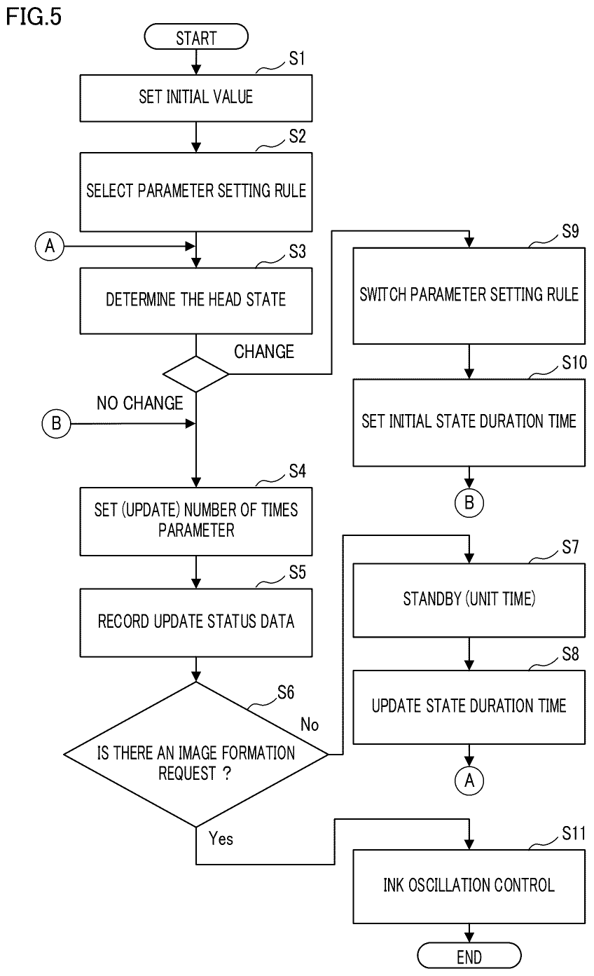

As will be described later, the printing control portion 8c executes ink oscillation control in the pre-ejection control (step S11 in FIG. 5). In the ink oscillation control, the printing control portion 8c supplies an ink oscillation signal to the plurality of piezoelectric elements 33 via the drive circuit 86.

The printing control portion 8c supplies the ink oscillation signal to the plurality of piezoelectric elements 33, thereby causing the plurality of piezoelectric elements 33 to oscillate. The plurality of piezoelectric elements 33 oscillate in response to the ink oscillation signal, thereby causing meniscus oscillation of the ink to occur in the plurality of nozzles 32.

The ink oscillation signal is a signal that causes the plurality of piezoelectric elements 33 to oscillate with enough energy to cause the meniscus oscillation of the ink. More specifically, the ink oscillation signal is a continuous pulse signal having a lower frequency and smaller energy than the drive signal.

When the ink oscillation control is being executed, the meniscus oscillation of the ink occurs inside the pressure chamber 35 and the nozzle 32 without the ink being ejected from the nozzle 32. Thus, inside the pressure chamber 35 and the nozzle 32, the temperature of the ink increases and the viscosity of the ink decreases.

In the pre-ejection control, the printing control portion 8c sets a frequency parameter related to the number of times the meniscus of the ink is oscillated (see steps S1 to S10 in FIG. 5). Furthermore, the printing control portion 8c executes the ink oscillation control from when a request for image formation by ejecting the ink is received until when the image formation is started (see steps S6 and S11 in FIG. 5).

In the ink oscillation control, the printing control portion 8c supplies the ink oscillation signal corresponding to the number of times parameter to a plurality of piezoelectric elements 33, thereby generating the meniscus oscillation of the ink a number of times corresponding to the number of times parameter.

### [Pre-Ink Ejection Control]

An example of the procedure of the pre-ink ejection control will be described below with reference to the flowchart shown in FIG. 5.

The pre-ink ejection control is an example of a process that achieves a nozzle unit control method for controlling each of the nozzle units 31. The CPU 81 that executes the pre-ink ejection control is an example of a processor that achieves the nozzle unit control method.

The printing control portion 8c starts the pre-ink ejection control when the CPU 81 is started. The printing control portion 8c executes the pre-ink ejection control under a condition in which the ink is not ejected from the plurality of nozzles 32.

The printing control portion 8c also starts the pre-ink ejection control when the printing process corresponding to the printing request is completed.

In the following description, S1, S2, . . . represent identification codes of a plurality of steps in the pre-ink ejection control. In the pre-ink ejection control, first, the process of step S1 is executed.

### Step S1

In step S1, the printing control portion 8c determines a nozzle unit state, which is the state of each of the nozzle units 31, and then sets an initial value for the state duration time.

In the present embodiment, the printing control portion 8c determines one of the capped state and the open state as the nozzle unit state. The state duration is a capped time or an open time.

The capped time is the duration of the capped state of each nozzle unit 31 under a condition in which the ink is not being ejected. The open time is the duration of the open state of each nozzle unit 31 under a condition in which the ink is not being ejected.

In a case in which the nozzle unit state when the process of step S1 is executed is the capped state, the printing control portion 8c sets the initial value of the duration time of the capped state as the initial value of the state duration time.

In a case in which the nozzle unit state when the process of step S1 is executed is the open state, the printing control portion 8c sets the initial value of the duration of the open state as the initial value of the state duration time.

The printing control portion 8c sets the initial value of the state duration time to 0 when the pre-ink ejection control is started in response to the end of the printing process corresponding to the printing request.

On the other hand, the printing control portion 8c sets an initial value of the state duration time based on update status data DT1 recorded in the secondary storage device 83 when the pre-ink ejection control is started in response to activation of the CPU 81.

The update status data DT1 and a method for setting the initial value of the state duration time based on the update status data DT1 will be described later.

After executing the process of step S1, the printing control portion 8c executes the process of step S2.

### Step S2

In step S2, the printing control portion 8c selects a parameter setting rule according to the nozzle unit state from a plurality of predetermined candidate rules.

The parameter setting rule is a rule for deriving the number of times parameter according to the state duration time. That is, the parameter setting rule represents the correspondence between the state duration time and the number of times parameter.

For example, each of the candidate rules is set as a lookup table that indicates the correspondence between the state duration time and the number of times parameter. In addition, each of the candidate rules may be set as a formula for calculating the number of times parameter from the state duration time.

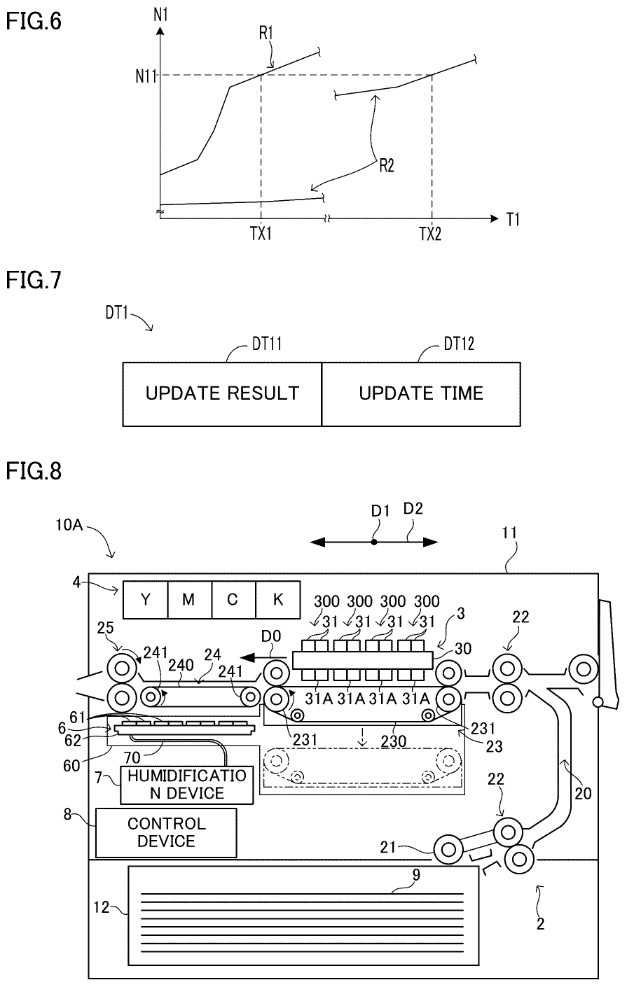

In the present embodiment, the plurality of candidate rules include a first candidate rule R1 that is adopted when the nozzle unit state is the open state, and a second candidate rule R2 that is adopted when the nozzle unit state is the capped state (see FIG. 6).

FIG. 6 is a diagram showing an example of two candidates for the parameter setting rule in a graph form. In FIG. 6, a portion of each of the first candidate rule R1 and the second candidate rule R2 is omitted.

In FIG. 6, the time T1 on the horizontal axis is the state duration time, and the number of times N1 on the vertical axis is the number of times parameter.

In the present embodiment, the number of times parameter is the number of times the printing control portion 8c causes the plurality of piezoelectric elements 33 to generated meniscus oscillation in the ink oscillation control.

Note that the number of times parameter may be a value representing the number of oscillations of the ink vibration signal. In each nozzle unit 31, the meniscus oscillation occurs a number of times corresponding to the number of oscillations of the ink oscillation signal.

As shown in FIG. 6, regardless of the nozzle unit state, the longer the state duration time, the larger the number of times parameter is set. In addition, when the nozzle unit state is the capped state, the rate of increase of the number of times parameter in response to the lapse of the state duration time is smaller than when the nozzle unit state is the open state.

After executing the process of step S2, the printing control portion 8c executes the process of step S3.

### Step S3

In step S3, the printing control portion 8c determines the nozzle unit state. As previously mentioned, the nozzle unit state is the open state or the capped state.

In a case in which the determined nozzle unit state has not changed from the previously determined state, the printing control portion 8c executes the process of step S4. Even in a case in which the process of step S3 is executed for the first time after the start of the pre-ejection control, the printing control portion 8c executes the process of step S4 following the process of step S3.

On the other hand, in a case in which the determined nozzle unit state has changed from the previously determined state, the printing control portion 8c executes the process of step S9.

Note that in a case in which the process of step S3 is executed following the processes of steps S1 and S2, the printing control portion 8c skips step S3 and executes the process of step S4.

### Step S4

In step S4, the printing control portion 8c sets the number of times parameter corresponding to the state duration time according to the parameter setting rule (see FIG. 6).

In a case in which the number of times parameter has already been set, the process of step S4 is a process of updating the number of times parameter.

As described above, the state duration time when the nozzle unit state is the capped state is the capped time, and the state duration time when the nozzle unit state is the open state is the open time.

After executing the process of step S4, the printing control portion 8c executes the process of step S5.

### Step S5

In step S5, the printing control portion 8c records the update status data DT1 including the data of an update result DT11 and the data of the update time DT12 in the secondary storage device 83 (see FIGS. 4 and 7).

In the present embodiment, the update result DT11 represents the number of times parameter updated in step S4.

The CPU 81 constantly keeps track of the current time. Data representing the time when the process of step S4 was executed is included in the update status data DT1 as update time DT12 data.

Note that the data of the update result DT11 may be data representing the state duration time corresponding to the number of times parameter updated in step S4. In this case, the state duration time corresponding to the update result DT11 is the initial value of the state duration time set in step S1, or the state duration time updated in step S8 described below.

After executing the process of step S5, the printing control portion 8c executes the process of step S6.

### Step S6

In step S6, the printing control portion 8c selects the next process depending on whether or not there is a request for image formation by ejecting the ink. In the present embodiment, the request for image formation is the receipt of the printing job.

The printing control portion 8c executes the process of step S7 when there is no request for image formation. On the other hand, the printing control portion 8c executes the process of step S11 when there is a request for image formation.

### Step S7

In step S7, the printing control portion 8c waits until a predetermined unit time has elapsed since the process of step S3 was executed.

The printing control portion 8c executes the process of step S8 when the unit time has elapsed.

### Step S8

In step S8, the printing control portion 8c updates the state duration time. The processes in step S7 and step S8 of the pre-ink ejection control are an example of a process for timing the capped time and the open time.

After executing the process of step S8, the printing control portion 8c executes the processes from step S3 onwards again.

### Step S9

In step S9, the printing control portion 8c switches the parameter setting rule to a rule corresponding to the new nozzle unit state.

In the present embodiment, the parameter setting rule is switched from one of the first candidate rule R1 and the second candidate rule R2 to the other.

After executing the process of step S9, the printing control portion 8c executes the process of step S10.

### Step S10

In step S10, the printing control portion 8c performs an initial setting for the state duration time.

For example, the printing control portion 8c sets the state duration time associated with the latest number of times parameter in the parameter setting rule after the change as a new initial value of the state duration time.

In FIG. 6, the number of times N11 is the latest value of the number of times parameter. In addition, the first duration time TX1 is the state duration time associated with the number of times N11 in the first candidate rule R1. The second duration time TX2 is the state duration time associated with the number of times N11 in the second candidate rule R2.

In a case in which the parameter setting rule after the change is the first candidate rule R1, the printing control portion 8c sets the first duration time TX1 as the initial value of the new state duration time. On the other hand, in a case in which the parameter setting rule after the change is the second candidate rule R2, the printing control portion 8c sets the second duration time TX2 as the initial value of the new state duration time.

After executing the process of step S10, the printing control portion 8c executes the processes from step S4 onwards again.

Here, the setting of the initial value of the state duration time based on the update status data DT1 in step S1 will be described. The update status data DT1 referred to in step S1 is data recorded in the secondary storage device 83 by the process of step S5.

In a case in which a power outage or a transition to a power saving mode occurs, the CPU 81 transitions from an operating state to a paused state, and the pre-ink ejection control is temporarily interrupted. Thereafter, when the CPU 81 is started up from the paused state, the printing control portion 8c executes the pre-ink ejection control.

In the case described above, in step S1, the printing control portion 8c sets an initial value of the state duration time based on the update status data DT1, the start-up time of the CPU 81, and the state of the nozzle unit 31 at the time of start-up.

More specifically, the printing control portion 8c selects the parameter setting rule at start-up that corresponds to the state of the nozzle unit at start-up. Furthermore, the printing control portion 8c derives the downtime, which is the difference between the current time and the paused time DT12 of the update status data DT1.

Furthermore, the printing control portion 8c specifies the state duration time associated with the number of times parameter represented by the update result DT11 of the update status data DT1 in the parameter setting rule at the time of start-up as a pre-pause duration time. The process of specifying the pre-pause duration time is similar to the process of specifying the first duration time TX1 or the second duration time TX2 based on the number of times N11 in step S10 (see FIG. 6).

Furthermore, the printing control portion 8c sets the time obtained by adding the paused time to the specified pre-pause duration time as an initial value of the state duration time. By reflecting the initial value set in this way in the state duration time, in step S4, the change in the viscosity of the ink during the period in which the CPU 81 was paused is reflected in the number of times parameter.

In step S5, data representing the update result of the state duration time may be included in the update status data DT1 as data of the update result DT11. In this case, in step S1 in response to the start of the CPU 81, the printing control portion 8c sets the time obtained by adding the paused time to the time represented by the update result DT11 as the initial value of the state duration time.

The nozzle unit state does not change in the paused state of the CPU 81. Therefore, the nozzle unit state when the CPU 81 is started up from the paused state is the nozzle unit state while the CPU 81 is paused.

Accordingly, in a case in which the nozzle unit state when the CPU 81 is started is the capped state, the initial value of the state duration time set in step S1 is the initial value of the capped time. On the other hand, in a case in which the nozzle unit state when the CPU 81 is started is the open state, the initial value of the state duration time set in step S1 is the initial value of the open time.

As described above, the printing control portion 8c sets the number of times parameter in accordance with the capped time and the open time (see steps S1 to S10).

### Step S11

In step S11, the printing control portion 8c executes the ink oscillation control to cause the ink ejection portion 31A of each nozzle unit 31 to generate the meniscus oscillation a number of times corresponding to the number of times parameter.

The printing control portion 8c executes the process of step S11 from when the image formation request is received until when the image formation is started.

After executing the process of step S11, the printing control portion 8c ends the pre-ink ejection control. After completing the pre-ink ejection control, the printing process 8c causes the inkjet portion 3 to execute the printing process in response to the image formation request.

By executing the pre-ink ejection control, the ink oscillation control is executed so that the meniscus oscillation occurs a number of times that takes into consideration both the open time and the capped time. Thus, appropriate viscosity of the ink before being ejected from the ink ejection portion 31A is achieved.

### Second Embodiment

Next, an inkjet recording apparatus 10A according to a second embodiment will be described with reference to FIG. 8.

The inkjet recording apparatus 10A includes a configuration in which a humidification device 7 is added to the inkjet recording apparatus 10. The humidification device 7 humidifies the inside of the cap 61 when each of the nozzle units 31 is in the capped state. The humidification device 7 generates moist air and supplies the moist air into the cap 61 via a hose 70.

In the present embodiment, the printing control portion 8c determines the capped state of the nozzle unit state by distinguishing between a first capped state and a second capped state in steps S1 and S3 of the pre-ink ejection control.

That is, the printing control portion 8c in the present embodiment determines one of the open state, the first capped state, and the second capped state as the nozzle unit state.

The first capped state is a state in which the inside of the cap 61 is not humidified by the humidification device 7. The second capped state is a state in which the inside of the cap 61 is humidified by the humidification device 7.

When the nozzle unit state is the second capped state, the viscosity of the ink in the ink ejection portion 31A improves over time.

On the other hand, after the operation of the humidification device 7 starts, it takes time for the inside of the cap 61 to be humidified to an extent that affects the viscosity of the ink.

The printing control portion 8c determines that the nozzle unit state is the first capped state during a period in which the humidification device 7 is not operating in the capped state. Furthermore, the printing control portion 8c determines that the nozzle unit state is the first capped state during a period from when the humidification device 7 starts operating in the capped state until a predetermined reference time has elapsed.

Furthermore, the printing control portion 8c determines that the nozzle unit state is the second capped state during a period after the reference time has elapsed since the operation of the humidification device 7 started in the capped state.

In the present embodiment, the printing control portion 8c measures the first capped time, the second capped time, or the open time as the state duration time in steps S7 and S8 of the pre-ink ejection control.

The first capped time is the duration time of the first capped state. The second capped time is the duration time of the second capped state.

In step S9 of the present embodiment, the selection candidates for the parameter setting rule include three candidate rules. The three candidate rules include a first candidate rule R1, a second candidate rule R2 and a third candidate rule.

The first candidate rule R1 is adopted when the nozzle unit state is the open state (see FIG. 6). The second candidate rule R2 is adopted when the nozzle unit state is the first capped state (see FIG. 6). The third candidate rule is adopted when the nozzle unit state is the second capped state.

As shown in FIG. 6, the first candidate rule R1 and the second candidate rule R2 are rules that increase the value of the number of times parameter as the state duration time elapses. On the other hand, the third candidate rule is a rule that decreases the value of the number of times parameter as the state duration time elapses.

In step S9, the printing control portion 8c in the present embodiment switches the parameter setting rule from one of the three candidate rules to another one. That is, the printing control portion 8c in the present embodiment sets the number of times parameter in accordance with the first capped time, the second capped time, and the open time.

In a case in which the inkjet recording apparatus 10A is employed, the same effects as in a case in which the inkjet recording apparatus 10 is employed can be obtained.

Note that in the present embodiment, the printing control portion 8c may determine that the nozzle unit state is the second capped state during the period from when the operation of the humidification device 7 is started to when the humidification device 7 is stopped. In this case, the third candidate rule is a rule that slightly increases or does not change the value of the number of times parameter during the period until the state duration time reaches the reference time.

### Third Embodiment

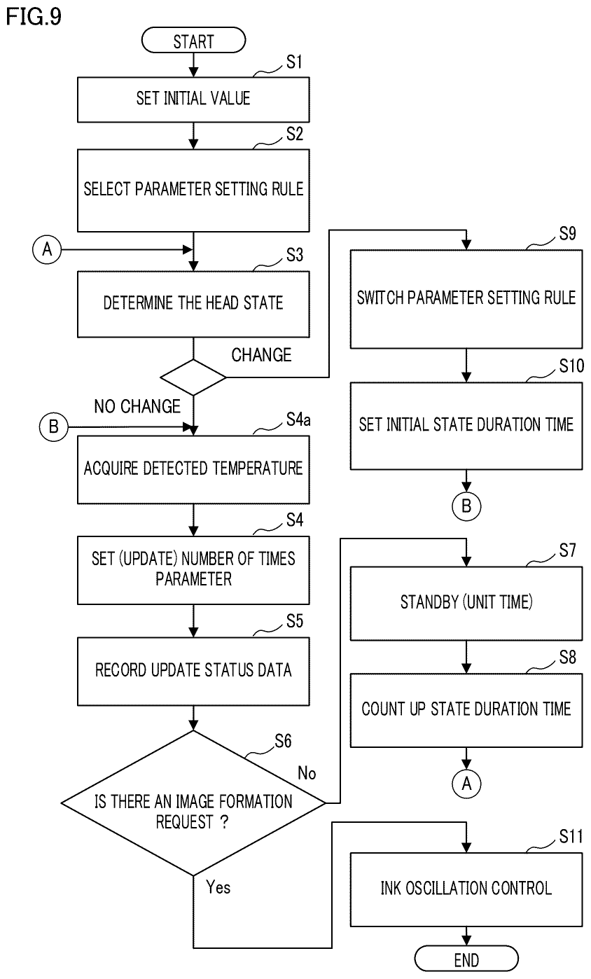

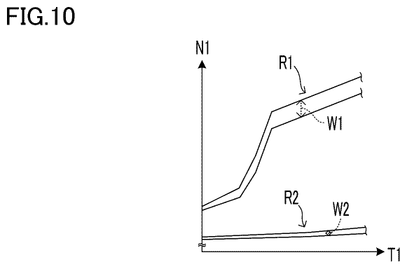

Next, an inkjet recording apparatus according to a third embodiment will be described with reference to FIG. 9 and FIG. 10.

The inkjet recording apparatus according to the present embodiment includes the same configuration as the inkjet recording apparatus 10 (see FIGS. 1 to 4).

In the present embodiment, the printing control portion 8c executes the pre-ink ejection control in accordance with the procedure shown in FIG. 9. Hereinafter, the differences between the procedure of the pre-ink ejection control shown in FIG. 9 and the procedure shown in FIG. 5 will be described.

The pre-ink ejection control shown in FIG. 9 is an example of a process that achieves the nozzle unit control method. The CPU 81 that executes the pre-ink ejection control shown in FIG. 9 is an example of a processor that achieves the nozzle unit control method.

In the present embodiment, the printing control portion 8c executes the pre-ink ejection control in accordance with the procedure shown in FIG. 5, to which step S4a has been added. Hereinafter, the steps of the pre-ink ejection control shown in FIG. 9 that differ from the steps shown in FIG. 5 will be described.

In the first candidate rule R1 in the present embodiment, a temperature correction width W1 of the value of the number of times parameter is set for each state duration time (see FIG. 10). Similarly, in the second candidate rule R2 in the present embodiment, a temperature correction width W2 of the value of the number of times parameter is set for each state duration time (see FIG. 10).

Lower and upper limits of the temperature correction widths W1 and W2 of the number of times parameter correspond to a first reference temperature and a second reference temperature, which are temperatures detected by the temperature sensor 37, respectively. The first reference temperature is higher than the second reference temperature.

That is, the first candidate rule R1 and the second candidate rule R2 are rules that set the number of times parameter to a larger value when the temperature detected by the temperature sensor 37 is low for each state duration time than when the temperature is high.

The printing control portion 8c in the present embodiment executes the process of step S4a before the process of step S4.

### <Step S4a>

In step S4a, the printing control portion 8c acquires the temperature detected by the temperature sensor 37. The temperature sensor 37 is an example of a temperature detection portion that detects the temperature of the nozzle unit 31.

### <Step S4>

In step S4, the printing control portion 8c sets the number of times parameter according to the state duration time in accordance with the parameter setting rule, and corrects the number of times parameter according to the temperature detected by the temperature sensor 37.

In the present embodiment, the printing control portion 8c sets the corrected number of times parameter by performing linear interpolation based on the temperature detected by the temperature sensor 37 for the temperature correction width W1 or W2 in the parameter setting rule.

By adopting the present embodiment, the number of times parameter is set in which the effect of the attachment state of the cap 61 and the temperature of the ink on the viscosity of the ink is reflected. As a result, the ink having an appropriate viscosity is achieved before being ejected from the ink ejection portion 31A.

In the present embodiment, an internal temperature sensor for detecting the temperature inside the main body 11 may be arranged inside the main body 11. The internal temperature sensor is an example of a temperature detection portion that detects the temperature around the nozzle unit 31.

In the case described above, the temperature detected by the internal temperature sensor may be used to correct the number of times parameter instead of the temperature detected by the temperature sensor 37.

### First Modification

Next, a first modification, which is a modification of the third embodiment, will be described.

In this modification, the inkjet recording apparatus 10 includes a humidity sensor that detects the humidity inside the main body 11. The humidity sensor is an example of a humidity detection portion that detects the humidity around the nozzle unit 31.

The printing control portion 8c in this application example acquires the humidity detected by the humidity sensor in the pre-ink ejection control step S4a.

Furthermore, the printing control portion 8c in this application example corrects the number of times parameter in accordance with the humidity detected by the humidity sensor in the pre-ink ejection control step S4.

For example, in the first candidate rule R1 and the second candidate rule R2 in this application example, a humidity correction width for the value of the number parameter is set for each state duration time. The humidity correction widths are set in the same manner as the temperature correction widths W1 and W2 (see FIG. 10).

In this application example, the first candidate rule R1 and the second candidate rule R2 are rules that set the number of times parameter to a larger value when the humidity detected by the humidity sensor is low compared to when the humidity is high for each state duration time.

Furthermore, in step S4, the printing control portion 8c sets the number of times parameter according to the state duration time in accordance with the parameter setting rule, and corrects the number of times parameter according to the humidity detected by the humidity sensor.

In the present application example, both correction of the number of times parameter based on the temperature detected by the temperature sensor 37 and the correction of the number of times parameter based on the humidity detected by the humidity sensor may be performed.

For example, an average value of the number of times parameter corrected based on the temperature detected by the temperature sensor 37 and the number of times parameter corrected based on the humidity detected by the humidity sensor is set as the number of times parameter.

In addition, the larger of the number of times parameter corrected based on the temperature detected by the temperature sensor 37 and the number of times parameter corrected based on the humidity detected by the humidity sensor may be set as the number of times parameter.

In addition, one or both of the correction of the number of times parameter based on the temperature detected by the temperature sensor 37 and the correction of the number of times parameter based on the humidity detected by the humidity sensor may be applied to the inkjet recording apparatus 10A.

### Second Modification

Next, a second modification, which is a modification of the third embodiment, will be described.

In this modification, the printing control portion 8c divides the plurality of piezoelectric elements 33 of each nozzle unit 31 into a plurality of element groups and controls the element groups. The plurality of element groups are divided according to their distance from the heater 36.

In this modification, the printing control portion 8c executes correction of the number of times parameter based on the temperature detected by the temperature sensor 37 for each of the element groups.

For example, in this application example, the temperature correction widths W1, W2 of the first candidate rule R1 and the second candidate rule R2 are set corresponding to each of the plurality of element groups.

In addition, the printing control portion 8c may correct the temperature detected by the temperature sensor 37 using a correction coefficient set in correspondence with the plurality of element groups. In this case, the printing control portion 8c uses the corrected detected temperature for correcting the number of times parameter.

In each nozzle unit 31, the influence of the heat of the heater 36 on the ink in the plurality of nozzles 32 may differ depending on the positions of the plurality of nozzles 32. Even in such a case, correction of the number of times parameter is performed according to the position of each nozzle 32 by adopting this application example.

### Third Modification

Next, a third modification, which is a modification of the inkjet recording apparatus 10, will be described.

In the inkjet recording apparatus 10, the inks of different colors have different viscosity change characteristics.

In this application example, different first candidate rules R1 and second candidate rules R2 are set for each ink color.

### Fourth Modification

Next, a fourth modification, which is a modification of the inkjet recording apparatus 10, will be described.

In the present modification, the inkjet recording apparatus 10 includes an ink recovery device that recovers ink ejected into the cap 61 when the nozzle unit is in the capped state.

In this application example, the printing control portion 8c supplies the drive signal to the plurality of piezoelectric elements 33 to cause the plurality of nozzles 31 to eject ink every time the capped time reaches a predetermined upper limit time.

In this application example, when ink is ejected into the cap 61 during the pre-ink ejection control, the printing control portion 8c initializes the state duration time to 0 and then executes the processing from step S3 onwards (see FIG. 5).

### Supplemental Notes

In the following, supplemental notes regarding an outline of the invention extracted from the above-described embodiments will be added. Note that the configurations and processing functions described in the following Supplemental Notes may be selected and combined as desired.

### Supplemental Note 1

A nozzle unit control method for controlling a nozzle unit including a plurality of nozzles capable of ejecting ink and a plurality of piezoelectric elements for pressurizing the ink supplied to the plurality of nozzles, the nozzle unit control method selectively switching the nozzle unit between a capped state in which the plurality of nozzles are covered by a cap and an open state in which the plurality of nozzles are opened by removing the cap;
the nozzle unit control method including:
a processor timing a capped time that is a duration time of the capped state of the nozzle unit when the ink is not being ejected, and an open time that is a duration time of the open state of the nozzle unit when the ink is not being ejected;
the processor setting a number of times parameter relating to a number of times that a meniscus of the ink in the plurality of nozzles is oscillated according to the capped time and the open time; and
the processor vibrating the plurality of piezoelectric elements to generate a meniscus oscillation of the ink a number of times corresponding to the number of times parameter during a period from when a request for image formation by ejecting the ink is received until when the image formation is started.

### Supplemental Note 2

In the nozzle unit control method according to Supplemental Note 1,
the processor sets the number of times parameter according to: a first capped time that is the capped time in a state in which an inner portion of the cap covering the plurality of nozzles is not humidified by a humidification device; a second capped time that is the capped time when the inner portion of the cap covering the plurality of nozzles is humidified by the humidification device; and the open time.

### Supplemental Note 3

In the nozzle unit control method according to Supplemental Note 1 or Supplemental Note 2,
the processor corrects the number of times parameter according to a temperature detected by a temperature detection portion that detects the temperature of the nozzle unit or the temperature around the nozzle unit.

### Supplemental Note 4

In the nozzle unit control method according to Supplemental Note 3,
the nozzle unit includes a heater; and
in a case in which the temperature detection portion is arranged in the nozzle unit,
the processor divides the plurality of piezoelectric elements into a plurality of element groups, and executes correction of the number of times parameter based on the temperature detected by the temperature detection portion for each of the plurality of element groups.

### Supplemental Note 5

In the nozzle unit control method according to any one of Supplemental Notes 1 to 4,
the processor corrects the number of times parameter according to humidity detected by a humidity detection portion that detects the humidity around the nozzle unit.

### Supplemental Note 6

The nozzle unit control method according to any one of Supplemental Notes 1 to 5 further includes:
the processor recording update status data including an update result of the capped time or the open time, or an update result of the number of times parameter, and update time data in a non-volatile storage device; and
the processor, when started from a paused state, setting an initial value of the capped time or the open time based on the update status data recorded in the non-volatile storage device, a start time, and a state of the nozzle unit at the time of starting.

### Supplemental Note 7

An inkjet recording apparatus including:
one or more nozzle units including a plurality of nozzles capable of ejecting ink and a plurality of piezoelectric elements that pressurize the ink supplied to the plurality of nozzles, and configured to selectively switch between a capped state in which the plurality of nozzles are covered by a cap and an open state in which the plurality of nozzles are opened by removing the cap; and
a processor configured to implement a nozzle unit control method according to any one of Supplemental Notes 1 to 6.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A nozzle unit control method for controlling a nozzle unit including a plurality of nozzles capable of ejecting ink and a plurality of piezoelectric elements for pressurizing the ink supplied to the plurality of nozzles, the nozzle unit control method selectively switching the nozzle unit between a capped state in which the plurality of nozzles are covered by a cap and an open state in which the plurality of nozzles are opened by removing the cap;
the nozzle unit control method comprising:
a processor timing a capped time that is a duration time of the capped state of the nozzle unit when the ink is not being ejected, and an open time that is a duration time of the open state of the nozzle unit when the ink is not being ejected;
the processor setting a number of times parameter relating to a number of times that a meniscus of the ink in the plurality of nozzles is oscillated according to the capped time and the open time; and
the processor vibrating the plurality of piezoelectric elements to generate a meniscus oscillation of the ink a number of times corresponding to the number of times parameter during a period from when a request for image formation by ejecting the ink is received until when the image formation is started.

2. The nozzle unit control method according to claim 1, wherein
the processor sets the number of times parameter according to: a first capped time that is the capped time in a state in which an inner portion of the cap covering the plurality of nozzles is not humidified by a humidification device; a second capped time that is the capped time when the inner portion of the cap covering the plurality of nozzles is humidified by the humidification device; and the open time.

3. The nozzle unit control method according to claim 1, wherein
the processor corrects the number of times parameter according to a temperature detected by a temperature detection portion that detects the temperature of the nozzle unit or the temperature around the nozzle unit.

4. The nozzle unit control method according to claim 3, wherein
the nozzle unit comprises a heater; and
in a case in which the temperature detection portion is arranged in the nozzle unit,
the processor divides the plurality of piezoelectric elements into a plurality of element groups, and executes correction of the number of times parameter based on the temperature detected by the temperature detection portion for each of the plurality of element groups.

5. The nozzle unit control method according to claim 1, wherein
the processor corrects the number of times parameter according to humidity detected by a humidity detection portion that detects the humidity around the nozzle unit.

6. The nozzle unit control method according to claim 1 further comprising:
the processor recording update status data including an update result of the capped time or the open time, or an update result of the number of times parameter, and update time data in a non-volatile storage device; and
the processor, when started from a paused state, setting an initial value of the capped time or the open time based on the update status data recorded in the non-volatile storage device, a start time, and a state of the nozzle unit at the time of starting.

7. An inkjet recording apparatus comprising:
one or more nozzle units including a plurality of nozzles capable of ejecting ink and a plurality of piezoelectric elements that pressurize the ink supplied to the plurality of nozzles, and configured to selectively switch between a capped state in which the plurality of nozzles are covered by a cap and an open state in which the plurality of nozzles are opened by removing the cap; and
a processor configured to implement a nozzle unit control method according to claim 1.
